(19) United States
(12) Patent Application Publication
(10) Pub. No.: US 2009/0096142 A1
(43) Pub. Date: Apr. 16, 2009

(54) TRANSMISSION MOUNT FOR CAR

(75) Inventor: Jae Heon KIM, Gyeongsangnam-do (KR)

Correspondence Address: ROBERTS MLOTKOWSKI SAFRAN & COLE, P.C.;Intellectual Property Department, P.O. Box 10064, MCLEAN, VA, 22102-8064, US

(73) Assignee: DTR CO., LTD., Gyeongsangnam-do (KR)

(21) Appl. No.: 12/185,438

(22) Filed: Aug. 4, 2008

(30) Foreign Application Priority Data
Oct. 16, 2007 (KR) 10-2007-0103848

(51) Int. Cl. F16F 7/00

(52) U.S. Cl. 267/141.1

(57) ABSTRACT

Disclosed is a transmission mount for a vehicle, which includes a vibration isolation member; an upper plate assembled with an upper portion of the vibration isolation member so as to surround the upper portion of the vibration isolation member; a lower plate assembled with a lower portion of the vibration isolation member so as to surround the lower portion of the vibration isolation member; and a pair of supporting brackets assembled on a surface of the upper plate in such a manner that the supporting brackets are symmetrical to each other so as to support the upper plate. Accordingly, the amount of displacement of the transmission mount according to the vibration of a vehicle can be minimized.

### BACKGROUND OF THE INVENTION

1. Field of the Invention

The present invention relates to a transmission mount for a vehicle, and more particularly to a transmission mount for a vehicle, which has an improved structure allowing vibration of a vehicle to be reduced.

2. Description of the Prior Art

Vibration and noise due to the vibration, which are generated during operation of a vehicle, increase fatigue of a user, and have an effect on the lifetime of parts of the vehicle.

In order to reduce such vibration of a vehicle, a transmission mount as a vibration isolation damper is mounted between a transmission and a chassis of the body of a vehicle.

As shown in FIG. 1, a conventional transmission mount 10 includes a vibration isolation member 20, an upper plate 30 assembled with the upper portion of the vibration isolation member 20 so as to surround the vibration isolation member 20, a lower plate 40 assembled with the lower portion of the vibration isolation member 20 so as to surround the lower part of the vibration isolation member 20, and a chassis bolt 50 assembled with the lower plate 40 so as to allow the transmission mount 10 to be assembled with a chassis (not shown).

The upper plate 30 includes a vibration absorber injecting hole 31, into which vibration absorber is injected so as to allow the vibration isolation member 20 to be formed between the upper plate 30 and the lower plate 40, and an assembling hole 32, with which a bolt is assembled so as to allow the transmission mount 10 to be coupled to a transmission (not shown).

However, such a conventional transmission mount can be displaced respective to the transmission when the vehicle is driven. Therefore, the conventional transmission mount cannot effectively absorb the vibration of the vehicle.

Moreover, when side collision of the vehicle occurs in an accident, the transmission mount 10 can be easily disassembled from the transmission or can be damaged.

### SUMMARY OF THE INVENTION

Accordingly, the present invention has been made to solve the above-mentioned problems occurring in the prior art, and the present invention provides a transmission mount for a vehicle, which can minimize the amount of displacement respective to a transmission.

Also, the present invention provides a transmission mount for a vehicle, which can be prevented from escaping from a transmission or being damaged when a side collision of a vehicle occurs in an accident.

In accordance with an aspect of the present invention, there is provided a transmission mount for a vehicle, which includes: a vibration isolation member; an upper plate assembled with an upper portion of the vibration isolation member so as to surround the upper portion of the vibration isolation member; a lower plate assembled with a lower portion of the vibration isolation member so as to surround the lower portion of the vibration isolation member; and a pair of supporting brackets assembled on a surface of the upper plate in such a manner that the supporting brackets are symmetrical to each other so as to support the upper plate.

It is preferable that the transmission mount for a vehicle further includes a bracket supporting pin having both ends assembled with the supporting brackets, respectively, so as to support the supporting bracket.

It is preferable that the upper plate comprises assembling holes formed on the surface of the upper plate in such a manner that the assembling holes are symmetrical to each other so as to allow the supporting brackets to be assembled with the assembling holes.

It is preferable that the upper plate further comprises slots formed on the surface of the upper plate in such a manner that the slots are symmetrical to each other so as to allow at least one portion of each supporting bracket to be inserted into each slot.

It is preferable that each supporting bracket is bent to have a shape of “L”.

It is preferable that a spacer, which protrudes outward and is bent while extending so as to support the lower plate, is assembled with the lower plate.

As described above, according to the present invention, by minimizing the amount of displacement of a transmission mount respective to a transmission for a vehicle, vibration and noise generated in operating a vehicle can be effectively reduced.

Also, a transmission mount can be prevented from being disassembled from a transmission or from being damaged in a side collision of a vehicle occurs in an accident.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view of a conventional transmission mount;

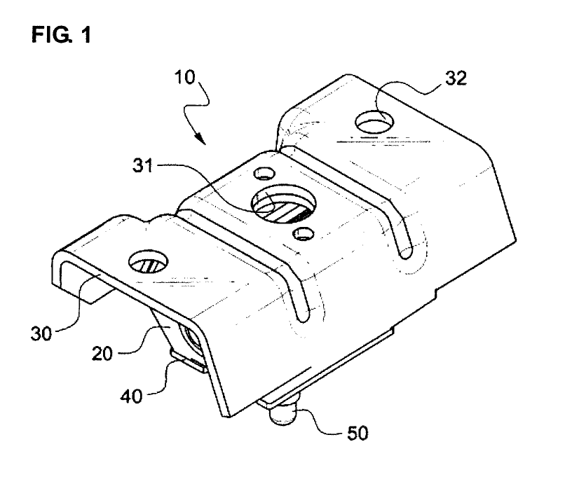

FIG. 2 is a perspective view of a transmission mount according to an embodiment of the present invention;

FIG. 3 is an exploded perspective view of FIG. 2;

FIG. 4 is a sectional view taken along the line IV-IV of FIG. 2;

FIG. 5 is a side view in a direction of the line V of FIG. 2; and

FIG. 6 is a sectional view of a transmission mount according to another embodiment of the present invention.

### DETAILED DESCRIPTION OF THE EXEMPLARY EMBODIMENTS

Hereinafter, an exemplary embodiment of the present invention will be described with reference to the accompanying drawings.

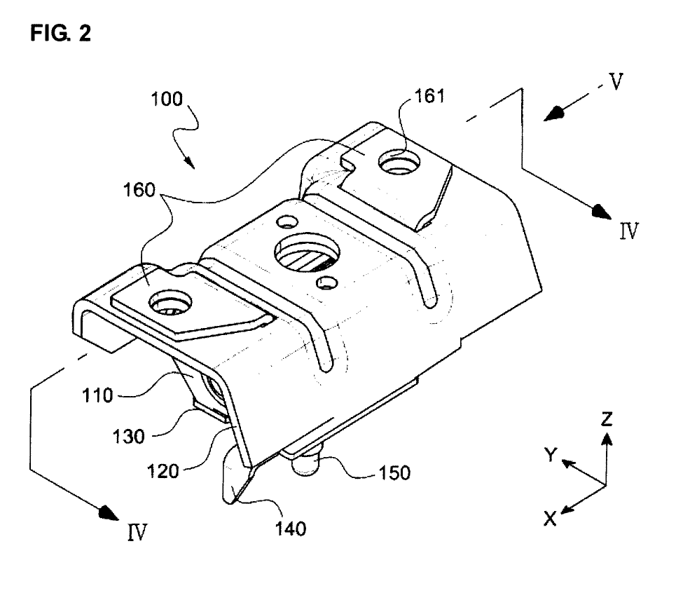

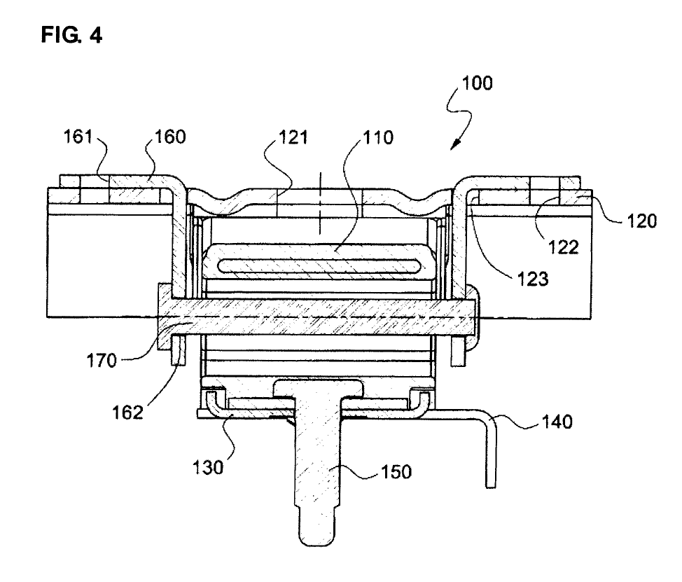

As shown in FIGS. 2 and 4, a transmission mount 100 for a vehicle according to the present invention includes a vibration isolation member 110, an upper plate 120, a lower plate 130, a spacer 140, a chassis bolt 150, a pair of support brackets 160 having each bracket assembling hole 161, and a bracket supporting pin 170.

According to an embodiment of the present invention, vibration isolation member 110 preferably includes rubber.

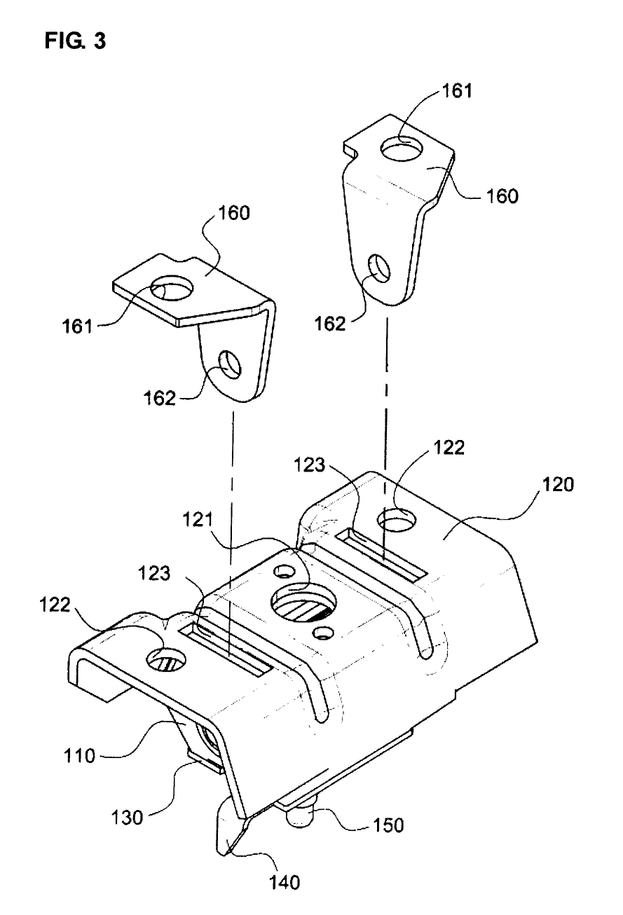

As shown in FIG. 3, the upper plate 120 is assembled with an upper portion of the vibration isolation member 110 while surrounding an upper portion of the vibration isolation member 110. The upper plate 120 includes slots 123, a vibration absorber injecting hole 121 formed at the center of the surface thereof, and assembling holes 122 formed on the surface of the upper plate symmetrically to each other, base on the vibration absorber injecting hole 121, the supporting brackets in a pair being assembled with the assembling holes, respectively.

Accordingly, within a mold, the vibration absorber (rubber), which is in a liquid-state, is injected into the interior of a die through the vibration absorber injecting hole 121 and is hardened. Then, the vibration absorber is taken out from the die and can be disposed between the upper plate 120 and the lower plate 130.

Moreover, the upper plate 120 and the supporting bracket 160 can be assembled with a transmission (not shown) through the assembling holes 122 by bolts.

As shown in FIG. 3, the slots 123 are formed on the surface of the upper plate 120 in such a manner that they are symmetrical to each other, and are positioned closer to the vibration absorber injecting hole 121 than the assembling holes 122, so that at least one portion of each supporting bracket 160 is inserted into each slot.

Accordingly, each supporting bracket 160 inserted into each slot 123 is fixed on a horizontal plane (refers to a plane formed by the coordinate of X and Y axes in FIG. 2) so that it can minimize the amount of displacement of the transmission mount 100 according to the vibration of a vehicle. Particularly, when a side collision of a vehicle occurs in an accident, the transmission mount 100 can be prevented from being disassembled from a transmission or being damaged.

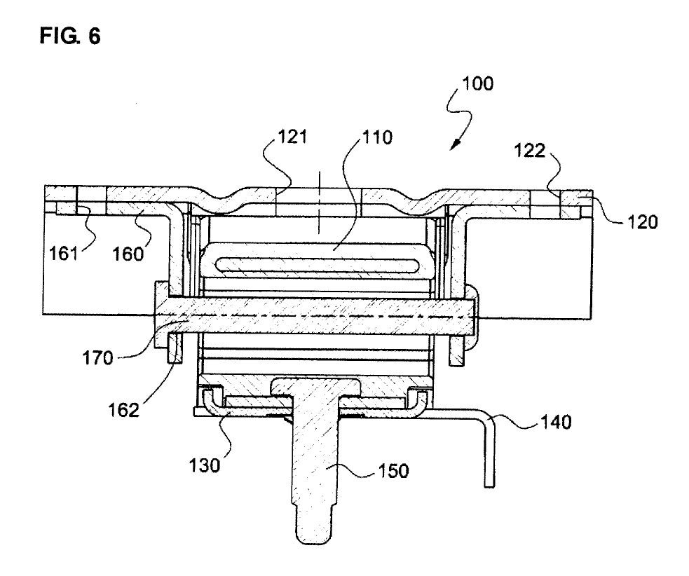

Meanwhile, although the slots 123 are formed on the upper plate 120 according to an embodiment of the present invention, the slots 123 cannot be formed on the upper plate 120 according to another embodiment of the present invention. At this time, as shown in FIG. 6, each assembling holes 122 of the upper plates 120 and each bracket assembling holes 161 of the supporting brackets 160 are assembled with each other through bolts in such a manner that a portion of each supporting bracket 160 makes contact with a lower surface of the upper plate 120.

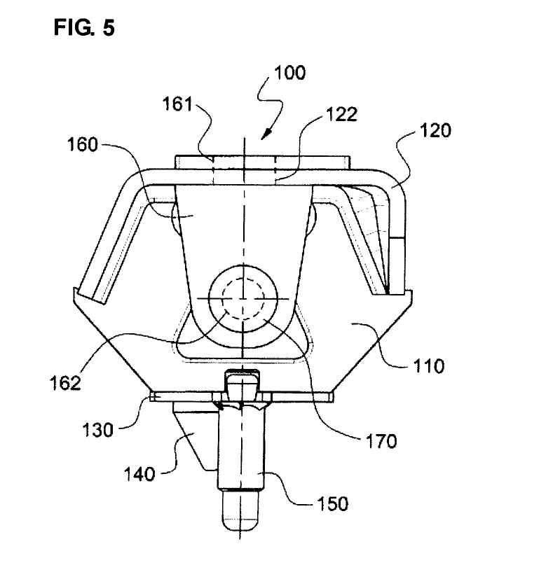

As shown in FIGS. 4 and 5, it is preferable that the lower plate 130 is assembled with a lower part of the vibration isolation member 110 so as to surround the lower part of the vibration isolation member 110 and the chassis bolt 150 is assembled therewith. Accordingly, the transmission mount 100 can be assembled with the chassis (not shown) of a vehicle through the chassis bolt 150 assembled with the lower plate 130. As shown in FIG. 2, the spacer 140 protrudes out of the lower plate 130 in such a manner that it is bent while extends, and is assembled with the lower plate 130 so as to support the lower plate 130.

Accordingly, an assembling error can be minimized when the transmission mount 100 is assembled with the chassis, and the transmission mount 100 can be further fixedly assembled with the chassis by inserting the spacer 140 into a slot (not shown) formed on the chassis.

As shown in FIGS. 3 and 4, a pair of supporting brackets 160 is provided and is assembled with the surface of the upper plate 120 in such a manner that the supporting brackets are symmetrical to each other so as to support the vibration isolation member 110 and the upper plate 120 respective to the transmission. According to an embodiment of the present invention, it is preferable that each supporting bracket 160 is bent to have a shape of “L”.

Accordingly, the transmission mount 100 is fixedly assembled with the transmission through the supporting bracket 160 so that the amount of the displacement of the transmission mount 100 respective to the transmission for a vehicle is minimized. Therefore, vibration and noise, which are generated in operating a vehicle, can be effectively reduced.

Also, the transmission mount 100 is fixedly assembled with the transmission on a horizontal plane (refers to a plane formed by the coordinate of X and Y axes in FIG. 2) through the supporting bracket 160 so that the transmission mount 100 can be prevented from escaping from the transmission or being damaged when a side collision of a vehicle occurs in an accident.

As shown in FIGS. 3 and 4, each supporting bracket 160 includes a bracket assembling hole 161, which corresponds to the assembling hole 122 of the upper plate 120 so as to allow the transmission mount 100 to be assembled with the transmission and a pin assembling hole 162 allowing the bracket supporting pin 170 to be assembled with the pair of the supporting brackets 160.

According to an embodiment of the present invention, as shown in FIGS. 3 and 5, the upper plate 120 is bent while having a roughly trapezoid sectional shape, and extends in a longitudinal direction. It is preferable that, in a state where the supporting brackets 160 in a pair are arranged while facing each other, they are inserted into the surface of the upper plate 120 in a transverse direction through each corresponding slot 123.

As shown in FIGS. 4 and 6, the bracket supporting pin 170 is assembled with one end of each supporting bracket 160 so as to support the supporting bracket 160.

Accordingly, the supporting bracket 160 is further fixedly assembled with the vibration isolation member 110 through the bracket supporting pin 170 so that the amount of the displacement of the transmission mount 100 respective to the transmission can be further minimized.

According to such a structure, the procedure of the transmission mount 100 for a vehicle according to one embodiment of the present invention being assembled will be described below with reference to FIGS. 2 to 5.

Firstly, a vibration absorber, such as rubber in a liquid-state, is injected into a mold through a vibration absorber injecting hole 121 of the upper plate 120 so that a vibration isolation member 110 is formed between the upper plate 120 and the lower plate 130 within the mold.

Then, when the vibration absorber is hardened within the mold, the upper plate 120, the lower upper 130, and the vibration isolation member 110 formed between the upper plate 120 and the lower upper 130 are taken out from the mold.

Supporting brackets 160 in a pair, which are bent while having a shape of “L”, are inserted into the corresponding slot 123 in such a manner that they face each other.

The supporting brackets 160 in a pair are fixedly assembled with each other through the bracket supporting pin 170 in such a manner that the bracket supporting pin 170 extends through the pin assembling hole 162 of each supporting bracket 160. At this time, one of both ends of the bracket supporting pin 170 can be coupled by welding.

The spacer 140 and the chassis bolt 150 are assembled with the lower plate 130.

While considering a longitudinal direction of the spacer 140, the chassis bolt 150 assembled with the lower plate 130 is assembled with a chassis of the vehicle, and each assembling hole 122 of the upper plate 120 is assembled with each bracket assembling hole 161 of the supporting brackets 160 through a bolt so that the transmission mount 100 is assembled with the transmission.

According to the present invention, the amount of the displacement of the transmission mount 100 respective to the transmission for a vehicle can be minimized.

What is claimed is:

1. A transmission mount for a vehicle, comprising:
a vibration isolation member;
an upper plate assembled with an upper portion of the vibration isolation member so as to surround the upper portion of the vibration isolation member;
a lower plate assembled with a lower portion of the vibration isolation member so as to surround the lower portion of the vibration isolation member; and
a pair of supporting brackets assembled on a surface of the upper plate in such a manner that the supporting brackets are symmetrical to each other so as to support the upper plate.

2. The transmission mount for a vehicle as claimed in claim 1, further comprising a bracket supporting pin having both ends assembled with the supporting brackets, respectively, so as to support the supporting bracket.

3. The transmission mount for a vehicle as claimed in claim 2, wherein the upper plate comprises assembling holes formed on the surface of the upper plate in such a manner that the assembling holes are symmetrical to each other so as to allow the supporting brackets to be assembled with the assembling holes.

4. The transmission mount for a vehicle as claimed in claim 3, wherein the upper plate further comprises slots formed on the surface of the upper plate in such a manner that the slots are symmetrical to each other so as to allow at least one portion of each supporting bracket to be inserted into each slot.

5. The transmission mount for a vehicle as claimed in claim 1, wherein each supporting bracket is bent to have a shape of “L”.

6. The transmission mount for a vehicle as claimed in claim 2, wherein each supporting bracket is bent to have a shape of “L”.

7. The transmission mount for a vehicle as claimed in claim 3, wherein each supporting bracket is bent to have a shape of “L”.

8. The transmission mount for a vehicle as claimed in claim 4, wherein each supporting bracket is bent to have a shape of “L”.

9. The transmission mount for a vehicle as claimed in claim 5, wherein a spacer, which protrudes outward and is bent while extending so as to support the lower plate, is assembled with the lower plate.

10. The transmission mount for a vehicle as claimed in claim 6, wherein a spacer, which protrudes outward and is bent while extending so as to support the lower plate, is assembled with the lower plate.

11. The transmission mount for a vehicle as claimed in claim 7, wherein a spacer, which protrudes outward and is bent while extending so as to support the lower plate, is assembled with the lower plate.

12. The transmission mount for a vehicle as claimed in claim 8, wherein a spacer, which protrudes outward and is bent while extending so as to support the lower plate, is assembled with the lower plate.
